(19) United States
(12) Patent Application Publication
(10) Pub. No.: US 2026/0203089 A1
(43) Pub. Date: Jul. 16, 2026

(54) CONFIGURING LAYER 3 HCI CLUSTER NODES FOR MULTI-CLOUD

(71) Applicant: Dell Products L.P., Round Rock, TX (US)

(72) Inventors: Yun SUN, Wuxi (CN); Hongbo GENG, Shanghai (CN); Bruce Bin HU, Shanghai (CN)

(73) Assignee: Dell Products L.P., Round Rock, TX (US)

(21) Appl. No.: 19/033,997

(22) Filed: Jan. 22, 2025

(30) Foreign Application Priority Data
Jan. 10, 2025 (CN) 202510041316.3

(51) Int. Cl. G06F 9/455

(52) U.S. Cl. CPC G06F 9/45558; G06F 2009/45595

(57) ABSTRACT

An information handling system may include at least one processor and a memory. The information handling system may be configured to query a plurality of nodes of an information handling system cluster for their network addresses, wherein the plurality of nodes and the information handling system are associated with a single layer-2 segment; receive a request from a cluster manager for the network addresses, wherein the cluster manager is associated with a different layer-2 segment; and transmit the network addresses to the cluster manager.

### TECHNICAL FIELD

The present disclosure relates in general to information handling systems, and more particularly to discovery and configuration of nodes of an information handling system cluster.

### BACKGROUND

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Hyper-converged infrastructure (HCI) is an IT framework that combines storage, computing, and networking into a single system in an effort to reduce data center complexity and increase scalability. Hyper-converged platforms may include a hypervisor for virtualized computing, software-defined storage, and virtualized networking, and they typically run on standard, off-the-shelf servers. One type of HCI solution is the Dell EMC VxRail™ system. Some examples of HCI systems may operate in various environments (e.g., an HCI management system such as the VMware® vSphere® ESXi™ environment, or any other HCI management system). Some examples of HCI systems may operate as software-defined storage (SDS) cluster systems (e.g., an SDS cluster system such as the VMware® vSAN™ system, or any other SDS cluster system).

In the HCI context (as well as other contexts), information handling systems may execute virtual machines (VMs) or containerized workloads for various purposes. A VM or container may generally comprise any program of executable instructions, or aggregation of programs of executable instructions, configured to execute a guest operating system on a hypervisor or host operating system in order to act through or in connection with the hypervisor/host operating system to manage and/or control the allocation and usage of hardware resources such as memory, central processing unit time, disk space, and input and output devices, and provide an interface between such hardware resources and application programs hosted by the guest operating system.

In a typical cluster setup, all the cluster nodes are in a single layer-2 segment (i.e., a single broadcast domain), with virtual LANs (VLANs) being used for network isolation of different types of traffic. An HCI management system, also referred to as an HCI manager, may discover and configure nodes easily through a layer-2 network service, such as multicast domain name system (mDNS).

However, large layer-2 broadcast domains can be susceptible to certain problems, such as broadcast storms, which can cause network outages. Also, it may be preferable to separate certain clients into different broadcast domains for security or policy reasons. Thus it would be advantageous for the HCI manager to be able to discover, configure, and manage HCI nodes across different layer-2 segments.

It should be noted that the discussion of a technique in the Background section of this disclosure does not constitute an admission of prior-art status. No such admissions are made herein, unless clearly and unambiguously identified as such.

### SUMMARY

In accordance with the teachings of the present disclosure, the disadvantages and problems associated with node discovery and configuration may be reduced or eliminated.

In accordance with embodiments of the present disclosure, an information handling system may include at least one processor and a memory. The information handling system may be configured to query a plurality of nodes of an information handling system cluster for their network addresses, wherein the plurality of nodes and the information handling system are associated with a single layer-2 segment; receive a request from a cluster manager for the network addresses, wherein the cluster manager is associated with a different layer-2 segment; and transmit the network addresses to the cluster manager.

In accordance with these and other embodiments of the present disclosure, a method may include an information handling system querying a plurality of nodes of an information handling system cluster for their network addresses, wherein the plurality of nodes and the information handling system are associated with a single layer-2 segment; the information handling system receiving a request from a cluster manager for the network addresses, wherein the cluster manager is associated with a different layer-2 segment; and the information handling system transmitting the network addresses to the cluster manager.

In accordance with these and other embodiments of the present disclosure, an article of manufacture may include a non-transitory, computer-readable medium having computer-executable instructions thereon that are executable by a processor of an information handling system for: querying a plurality of nodes of an information handling system cluster for their network addresses, wherein the plurality of nodes and the information handling system are associated with a single layer-2 segment; receiving a request from a cluster manager for the network addresses, wherein the cluster manager is associated with a different layer-2 segment; and transmitting the network addresses to the cluster manager.

Technical advantages of the present disclosure may be readily apparent to one skilled in the art from the figures, description and claims included herein. The objects and advantages of the embodiments will be realized and achieved at least by the elements, features, and combinations particularly pointed out in the claims.

It is to be understood that both the foregoing general description and the following detailed description are examples and explanatory and are not restrictive of the claims set forth in this disclosure.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 illustrates a block diagram of an example information handling system, in accordance with embodiments of the present disclosure;

FIG. 2 illustrates an example architecture, in accordance with embodiments of the present disclosure; and

FIGS. 3-4 illustrate example sequence diagram methods, in accordance with embodiments of the present disclosure.

### DETAILED DESCRIPTION

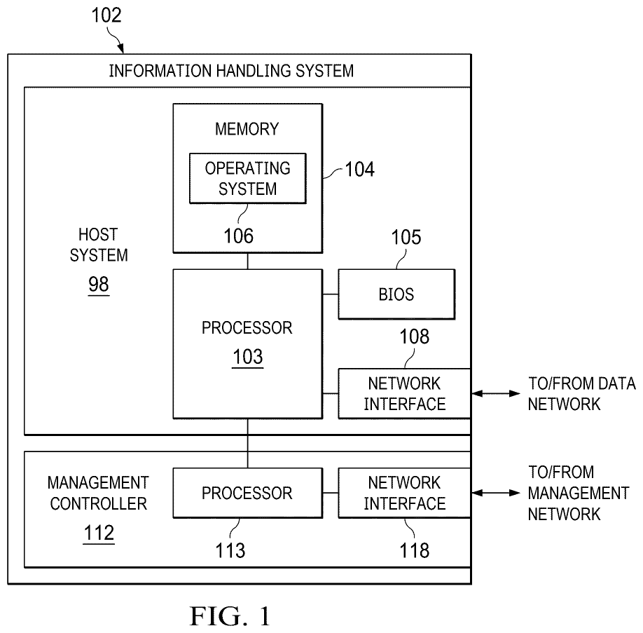

Preferred embodiments and their advantages are best understood by reference to FIGS. 1 through 4, wherein like numbers are used to indicate like and corresponding parts.

For the purposes of this disclosure, the term “information handling system” may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, an information handling system may be a personal computer, a personal digital assistant (PDA), a consumer electronic device, a network storage device, or any other suitable device and may vary in size, shape, performance, functionality, and price. The information handling system may include memory, one or more processing resources such as a central processing unit (“CPU”) or hardware or software control logic. Additional components of the information handling system may include one or more storage devices, one or more communications ports for communicating with external devices as well as various input/output (“I/O”) devices, such as a keyboard, a mouse, and a video display. The information handling system may also include one or more buses operable to transmit communication between the various hardware components.

For purposes of this disclosure, when two or more elements are referred to as “coupled” to one another, such term indicates that such two or more elements are in electronic communication or mechanical communication, as applicable, whether connected directly or indirectly, with or without intervening elements.

When two or more elements are referred to as “coupleable” to one another, such term indicates that they are capable of being coupled together.

For the purposes of this disclosure, the term “computer-readable medium” (e.g., transitory or non-transitory computer-readable medium) may include any instrumentality or aggregation of instrumentalities that may retain data and/or instructions for a period of time. Computer-readable media may include, without limitation, storage media such as a direct access storage device (e.g., a hard disk drive or floppy disk), a sequential access storage device (e.g., a tape disk drive), compact disk, CD-ROM, DVD, random access memory (RAM), read-only memory (ROM), electrically erasable programmable read-only memory (EEPROM), and/or flash memory; communications media such as wires, optical fibers, microwaves, radio waves, and other electromagnetic and/or optical carriers; and/or any combination of the foregoing.

For the purposes of this disclosure, the term “information handling resource” may broadly refer to any component system, device, or apparatus of an information handling system, including without limitation processors, service processors, basic input/output systems, buses, memories, I/O devices and/or interfaces, storage resources, network interfaces, motherboards, and/or any other components and/or elements of an information handling system.

For the purposes of this disclosure, the term “management controller” may broadly refer to an information handling system that provides management functionality (typically out-of-band management functionality) to one or more other information handling systems. In some embodiments, a management controller may be (or may be an integral part of) a service processor, a baseboard management controller (BMC), a chassis management controller (CMC), or a remote access controller (e.g., a Dell Remote Access Controller (DRAC) or Integrated Dell Remote Access Controller (iDRAC)).

FIG. 1 illustrates a block diagram of an example information handling system 102, in accordance with embodiments of the present disclosure. In some embodiments, information handling system 102 may comprise a server chassis configured to house a plurality of servers or “blades.” In other embodiments, information handling system 102 may comprise a personal computer (e.g., a desktop computer, laptop computer, mobile computer, and/or notebook computer). In yet other embodiments, information handling system 102 may comprise a storage enclosure configured to house a plurality of physical disk drives and/or other computer-readable media for storing data (which may generally be referred to as “physical storage resources”). As shown in FIG. 1, information handling system 102 may comprise a processor 103, a memory 104 communicatively coupled to processor 103, a BIOS 105 (e.g., a UEFI BIOS) communicatively coupled to processor 103, a network interface 108 communicatively coupled to processor 103, and a management controller 112 communicatively coupled to processor 103.

In operation, processor 103, memory 104, BIOS 105, and network interface 108 may comprise at least a portion of a host system 98 of information handling system 102. In addition to the elements explicitly shown and described, information handling system 102 may include one or more other information handling resources.

Processor 103 may include any system, device, or apparatus configured to interpret and/or execute program instructions and/or process data, and may include, without limitation, a microprocessor, microcontroller, digital signal processor (DSP), application specific integrated circuit (ASIC), or any other digital or analog circuitry configured to interpret and/or execute program instructions and/or process data. In some embodiments, processor 103 may interpret and/or execute program instructions and/or process data stored in memory 104 and/or another component of information handling system 102.

Memory 104 may be communicatively coupled to processor 103 and may include any system, device, or apparatus configured to retain program instructions and/or data for a period of time (e.g., computer-readable media). Memory 104 may include RAM, EEPROM, a PCMCIA card, flash memory, magnetic storage, opto-magnetic storage, or any suitable selection and/or array of volatile or non-volatile memory that retains data after power to information handling system 102 is turned off.

As shown in FIG. 1, memory 104 may have stored thereon an operating system 106. Operating system 106 may comprise any program of executable instructions (or aggregation of programs of executable instructions) configured to manage and/or control the allocation and usage of hardware resources such as memory, processor time, disk space, and input and output devices, and provide an interface between such hardware resources and application programs hosted by operating system 106. In addition, operating system 106 may include all or a portion of a network stack for network communication via a network interface (e.g., network interface 108 for communication over a data network). Although operating system 106 is shown in FIG. 1 as stored in memory 104, in some embodiments operating system 106 may be stored in storage media accessible to processor 103, and active portions of operating system 106 may be transferred from such storage media to memory 104 for execution by processor 103.

Network interface 108 may comprise one or more suitable systems, apparatuses, or devices operable to serve as an interface between information handling system 102 and one or more other information handling systems via an in-band network. Network interface 108 may enable information handling system 102 to communicate using any suitable transmission protocol and/or standard. In these and other embodiments, network interface 108 may comprise a network interface card, or “NIC.” In these and other embodiments, network interface 108 may be enabled as a local area network (LAN)-on-motherboard (LOM) card.

Management controller 112 may be configured to provide management functionality for the management of information handling system 102. Such management may be made by management controller 112 even if information handling system 102 and/or host system 98 are powered off or powered to a standby state. Management controller 112 may include a processor 113, memory, and a network interface 118 separate from and physically isolated from network interface 108.

As shown in FIG. 1, processor 113 of management controller 112 may be communicatively coupled to processor 103. Such coupling may be via a Universal Serial Bus (USB), System Management Bus (SMBus), and/or one or more other communications channels.

Network interface 118 may be coupled to a management network, which may be separate from and physically isolated from the data network as shown. Network interface 118 of management controller 112 may comprise any suitable system, apparatus, or device operable to serve as an interface between management controller 112 and one or more other information handling systems via an out-of-band management network. Network interface 118 may enable management controller 112 to communicate using any suitable transmission protocol and/or standard. In these and other embodiments, network interface 118 may comprise a network interface card, or “NIC.” Network interface 118 may be the same type of device as network interface 108, or in other embodiments it may be a device of a different type.

As discussed above, information handling system 102 may be a node of an HCI system. In some cases, the nodes of an HCI system may be split into multiple broadcast domains (e.g., each rack of nodes may be configured with its own subnet). The nodes that are all within a single broadcast domain can discover one another using a tool such as mDNS, but discovery of nodes in other broadcast domains is more challenging. Embodiments of this disclosure provide administrators with techniques for discovery and configuration of nodes that span across different layer-3 subnets.

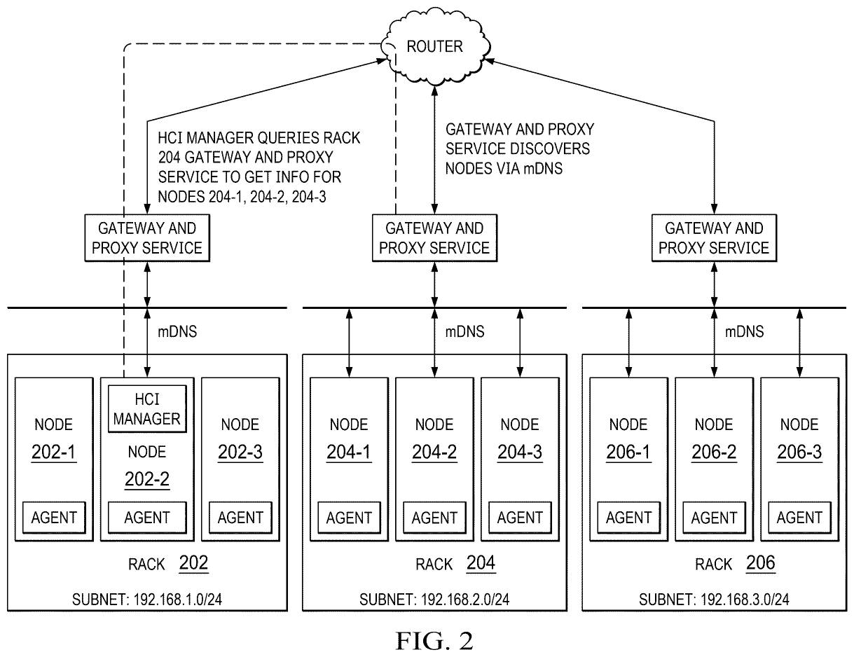

FIG. 2 shows one example architecture, including racks 202, 204, and 206. Each rack includes a plurality of corresponding nodes, and each rack is on its own subnet. One node runs the HCI manager for the whole cluster. Each node also runs an agent that provides a RESTful API service to the HCI manager, which may be used to interact with the hypervisor.

A gateway and proxy service for each rack may run on an information handling system at that rack (e.g., on a designated node of the rack, on a management controller, on a rack switch, or in any other suitable arrangement). This gateway and proxy service may provide both traditional network data forwarding services as well as node proxy services.

In order to use this architecture, the nodes may first be wired up and connected to their switches, and the gateway and proxy service on each rack may be configured. Then the nodes on each rack may be powered on. In this example, the HCI manager may run on node 202-2 of rack 202 as shown.

Each gateway and proxy service may then discover (e.g., by using broadcast mDNS messages) all of the nodes within its own subnet. Each gateway and proxy service may then communicate with the other gateway and proxy services to collect information about all of the nodes in the other racks. This information (e.g., including IP addresses, service tags, and any other relevant information) may be saved into a cache that is local to each gateway and proxy service, which may be updated if and when configurations change.

The HCI manager may then query all of the gateway and proxy services for each rack to receive the information about all of the nodes in each rack. (In some embodiments, the HCI manager need not query the gateway and proxy service for its own rack, but instead may rely on mDNS broadcasts for discovering the nodes in its own subnet.)

The HCI manager may accomplish this by automatically discovering the gateway and proxy services for the racks, or a user may manually provide the HCI manager with their IP addresses or subnets. In other embodiments, each gateway and proxy service may perform discovery to find the IP addresses for each of the other gateway and proxy services, saving this information in its cache along with the node-specific information discussed above. The HCI manager may then retrieve this information from the gateway and proxy service for its own rack.

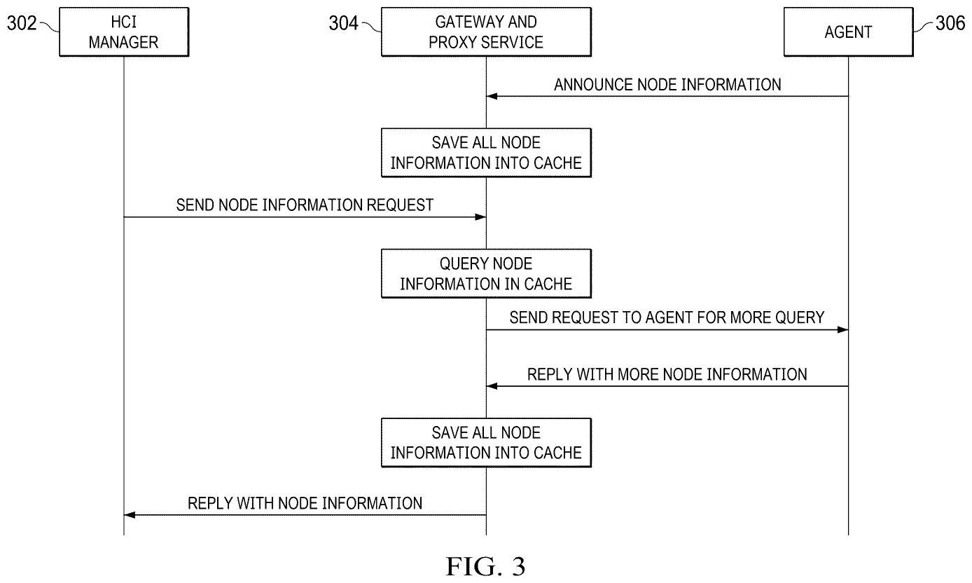

FIG. 3 shows a sequence diagram of one embodiment of this discovery process.

When the nodes power on, each one executes an agent 306 which announces the node information to the local gateway and proxy service 304. When HCI manager 302 sends a node information request to gateway and proxy service 304, it may respond with all of the node information in its cache. In some instances, it may first also request updated information from the nodes to ensure that its cached data is up to date.

In addition to node discovery, embodiments may also provide for configuring the network settings and other operational characteristics of the various nodes once they have been discovered.

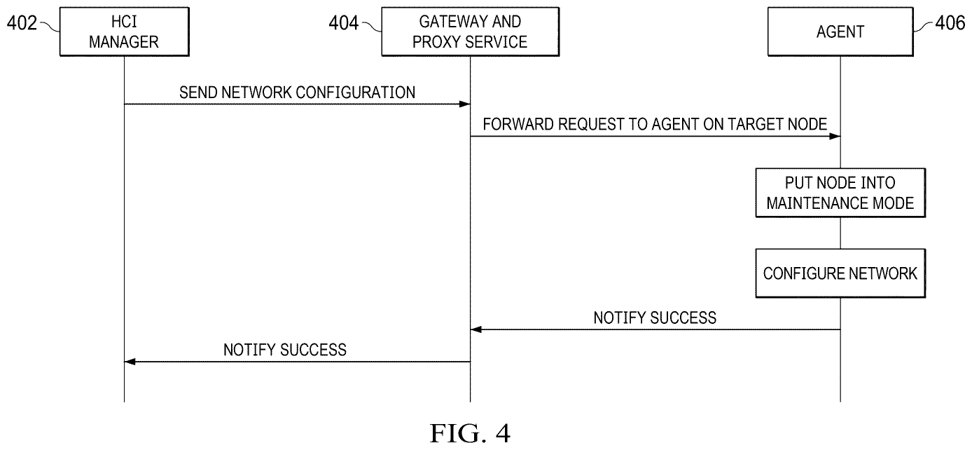

FIG. 4 shows a sequence diagram of one embodiment of this configuration process.

HCI manager 402 may send a new network configuration to gateway and proxy service 404. Gateway and proxy service 404 may forward the request to agent 406 executing on the target node.

Agent 406 may then put the node in question into a maintenance mode (e.g., involving transferring any workloads to other nodes), then configure the node with the new network configuration information.

After the new network configuration is applied, agent 406 may will send an event message to gateway and proxy service 404, which may forward the message to HCI manager 402.

If agent 406 fails to apply the new network configuration, or if it fails to send events acknowledging the new network configuration, the node may will roll back to its original network configuration and send an event message indicative of this to HCI manager 402.

One of ordinary skill in the art with the benefit of this disclosure will understand that the preferred initialization point for the methods depicted in FIGS. 3-4 and the order of the steps comprising the methods may depend on the implementation chosen. In these and other embodiments, the methods may be implemented as hardware, firmware, software, applications, functions, libraries, or other instructions. Further, although FIGS. 3-4 disclose a particular number of steps to be taken with respect to the disclosed methods, the methods may be executed with greater or fewer steps than depicted. The methods may be implemented using any of the various components disclosed herein (such as the components of FIG. 1), and/or any other system operable to implement the methods.

This disclosure encompasses all changes, substitutions, variations, alterations, and modifications to the exemplary embodiments herein that a person having ordinary skill in the art would comprehend. Similarly, where appropriate, the appended claims encompass all changes, substitutions, variations, alterations, and modifications to the exemplary embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative.

Further, reciting in the appended claims that a structure is “configured to” or “operable to” perform one or more tasks is expressly intended not to invoke 35 U.S.C. § 112(f) for that claim element. Accordingly, none of the claims in this application as filed are intended to be interpreted as having means-plus-function elements. Should Applicant wish to invoke § 112(f) during prosecution, Applicant will recite claim elements using the “means for [performing a function]” construct.

All examples and conditional language recited herein are intended for pedagogical objects to aid the reader in understanding the invention and the concepts contributed by the inventor to furthering the art, and are construed as being without limitation to such specifically recited examples and conditions. Although embodiments of the present inventions have been described in detail, it should be understood that various changes, substitutions, and alterations could be made hereto without departing from the spirit and scope of the disclosure.

What is claimed is:

1. An information handling system comprising:
at least one processor; and
a memory;
wherein the information handling system is configured to:
query a plurality of nodes of an information handling system cluster for their network addresses, wherein the plurality of nodes and the information handling system are associated with a single layer-2 segment;
receive a request from a cluster manager for the network addresses, wherein the cluster manager is associated with a different layer-2 segment; and
transmit the network addresses to the cluster manager.

2. The information handling system of claim 1, wherein the information handling system cluster is a hyper-converged infrastructure (HCI) system.

3. The information handling system of claim 1, wherein the query for the network addresses comprises a multicast domain name service (mDNS) broadcast message.

4. The information handling system of claim 1, further configured to:
receive a configuration instruction from the cluster manager for a particular node of the plurality of nodes; and
forward the configuration instruction to an agent executing on the particular node, wherein the agent is configured to put the particular node into a maintenance mode and apply the configuration instruction to the particular node.

5. The information handling system of claim 4, further configured to:
receive a success notification from the agent; and
forward the success notification to the cluster manager.

6. The information handling system of claim 1, further configured to:
store the network addresses in a local cache; and
update the cache in response to a change in the plurality of nodes.

7. A method comprising:
an information handling system querying a plurality of nodes of an information handling system cluster for their network addresses, wherein the plurality of nodes and the information handling system are associated with a single layer-2 segment;
the information handling system receiving a request from a cluster manager for the network addresses, wherein the cluster manager is associated with a different layer-2 segment; and
the information handling system transmitting the network addresses to the cluster manager.

8. The method of claim 7, wherein the information handling system cluster is a hyper-converged infrastructure (HCI) system.

9. The method of claim 7, wherein the query for the network addresses comprises a multicast domain name service (mDNS) broadcast message.

10. The method of claim 7, further comprising:
the information handling system receiving a configuration instruction from the cluster manager for a particular node of the plurality of nodes; and
the information handling system forwarding the configuration instruction to an agent executing on the particular node, wherein the agent is configured to put the particular node into a maintenance mode and apply the configuration instruction to the particular node.

11. The method of claim 10, further comprising:
receiving a success notification from the agent; and
forwarding the success notification to the cluster manager.

12. The method of claim 7, further comprising:
storing the network addresses in a local cache; and
updating the cache in response to a change in the plurality of nodes.

13. An article of manufacture comprising a non-transitory, computer-readable medium having computer-executable instructions thereon that are executable by a processor of an information handling system for:
querying a plurality of nodes of an information handling system cluster for their network addresses, wherein the plurality of nodes and the information handling system are associated with a single layer-2 segment;
receiving a request from a cluster manager for the network addresses, wherein the cluster manager is associated with a different layer-2 segment; and
transmitting the network addresses to the cluster manager.

14. The article of manufacture of claim 13, wherein the information handling system cluster is a hyper-converged infrastructure (HCI) system.

15. The article of manufacture of claim 13, wherein the query for the network addresses comprises a multicast domain name service (mDNS) broadcast message.

16. The article of manufacture of claim 13, wherein the instructions are further executable for:
receiving a configuration instruction from the cluster manager for a particular node of the plurality of nodes; and
forwarding the configuration instruction to an agent executing on the particular node, wherein the agent is configured to put the particular node into a maintenance mode and apply the configuration instruction to the particular node.

17. The article of manufacture of claim 16, wherein the instructions are further executable for:
receiving a success notification from the agent; and
forwarding the success notification to the cluster manager.

18. The article of manufacture of claim 13, wherein the instructions are further executable for:
storing the network addresses in a local cache; and
updating the cache in response to a change in the plurality of nodes.
